(19) United States
(12) Patent Application Publication
(10) Pub. No.: US 2005/0055278 A1
(43) Pub. Date: Mar. 10, 2005

(54) Payment method for in-flight entertainment device rentals having self-contained audio-visual presentations

(75) Inventor: William J. Boyer JR., Lakewood, WA (US)

Correspondence Address: DAVIS WRIGHT TREMAINE, LLP, 2600 CENTURY SQUARE, 1501 FOURTH AVENUE, SEATTLE, WA, 98101-1688, US

(73) Assignee: Aircraft Protective Systems, Inc., Tacoma, WA (US)

(21) Appl. No.: 10/657,816

(22) Filed: Sep. 8, 2003

(51) Int. Cl. G06F 17/60

(52) U.S. Cl. 705/17

(57) ABSTRACT

A payment method of in-flight entertainment device (IFED) rentals having self-contained audiovisual presentations is disclosed. A self-contained IFED has internal storage configured to contain current releases of movies and other audiovisual presentations. The method addresses aspects related to in-flight collection of payment and credential information and tracing related to lost self-contained IFEDs.

### BACKGROUND OF THE INVENTION

1. Field of the Invention

The present invention is directed generally to payment for device rentals and, more particularly, to payment for devices having self-contained audio-visual presentations for rent to passengers of conveyances such as commercial airline flights.

2. Description of the Related Art

Rental of entertainment devices having self-contained audio-visual presentations to be used by passengers during a commercial airline flight can provide individually tailored current entertainment and other services to the passengers during the commercial flight. Unfortunately, conventional methods of payment have not addressed methods usable to obtain payment for such self-contained in-flight entertainment device rentals.

### BRIEF SUMMARY OF THE INVENTION

The present invention resides in a payment method for in-flight entertainment device rentals having self-contained audio-visual presentations. Aspects generally are performed on-board a commercial aircraft and include electronically swiping an identification card indicating attendant and commercial airline flight, electronically swiping a financial card to collection identification information for payment of rental of a self-contained in-flight entertainment device, distributing the self-contained in-flight entertainment device to a passenger, noting an identification of the self-contained in-flight entertainment device, and recording an association between the identification of the self-contained in-flight entertainment device and information associated with the passenger. Other features and advantages of the invention will become apparent from the following detailed description, taken in conjunction with the accompanying drawings.

### BRIEF DESCRIPTION OF THE SEVERAL VIEWS OF THE DRAWING(S)

FIG. 1 is a side-view of a passenger viewing an audio-visual presentation being presented by a representative self-contained in-flight entertainment device (IFED) rental while traveling during a commercial flight.

FIG. 2 is a perspective view of the self-contained IFED of FIG. 1.

FIG. 3 is a top cross-sectional schematic view of a top deck of a commercial aircraft generally showing location of seating and storage areas accessible by flight attendants.

FIG. 4 is a side cross-sectional schematic view of a top and bottom deck of the commercial aircraft of FIG. 3 showing location of seating, storage areas accessible by flight attendants, and storage areas accessible only on the ground.

FIG. 5 is a perspective view of a protective pouch containing the self-contained IFED of FIG. 1.

FIG. 6A is a top plan view of a carrying case used to transport a plurality of the self-contained IFEDs of FIG. 1.

FIG. 6B is a cross-sectional side view of the carrying case of FIG. 6A.

FIG. 7 is a perspective view of an implementation of a wireless card swipe unit according to the present invention.

FIG. 8 is a flowchart of an implementation of a method of payment during distribution to passengers for rental of the self-contained IFED of FIG. 1.

FIG. 9 is a flowchart of an implementation of a method of payment during collection from passengers of the rented self-contained IFEDs of FIG. 1.

### DETAILED DESCRIPTION OF THE INVENTION

A payment method of in-flight entertainment device (IFED) rentals having self-contained audiovisual presentations is disclosed herein. A self-contained IFED has internal storage configured to contain current releases of movies and other audiovisual presentations. According to implementations of the present method, the self-contained IFED can be rented by passengers of commercial airline flights for viewing of such movies and other audiovisual presentations during the flight. Use of the self-contained IFED provides a selection of audiovisual presentations from which the passengers renting the self-contained IFED can choose. This individualizes the selection opportunity provided to each passenger by the self-contained IFED and increases the potential for enjoyment by the passengers compared with conventional systems that display one audiovisual presentation to a large group of passengers with the passengers having no input on the particular audiovisual property being presented.

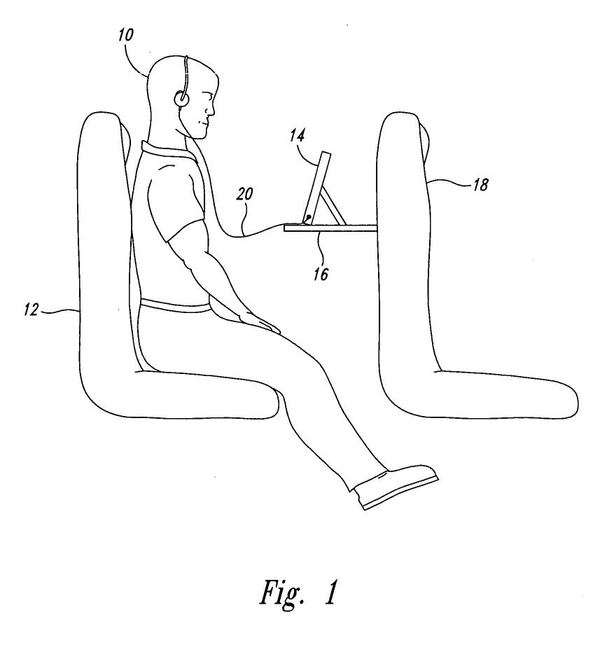

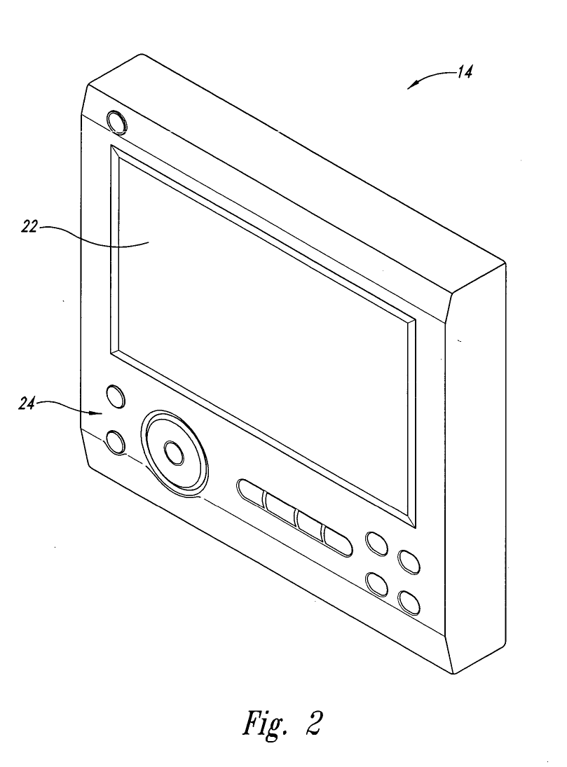

As shown in FIG. 1, a passenger 10 while seated in aircraft seat 12 can view a movie being presented by a self-contained IFED 14 resting on a seat back table 16 that is connected to a forwardly adjacent aircraft seat 18. As is conventional practice, earphones 20 can be used to listen to the audio portion of the presentation without disturbing fellow passengers. The self-contained IFED 14, further depicted in FIG. 2, includes a display 22 for viewing presentations and controls 24 for selection of presentations and adjustment of the self-contained IFED.

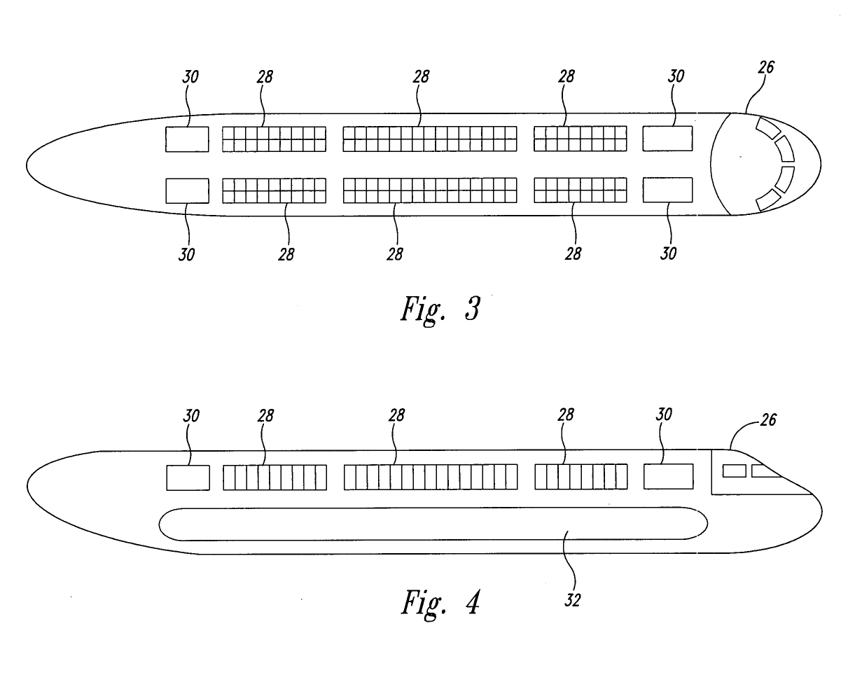

A representative aircraft 26, shown in FIG. 3, includes passenger seats 28 and in-flight storage 30 accessible by flight attendants (not shown) during flight of the aircraft. As shown in FIG. 4, the representative aircraft 26 also includes ground-only accessible storage 32 generally configured to contain luggage and other items to be loaded and unloaded by ground crew when the aircraft is parked at an airport.

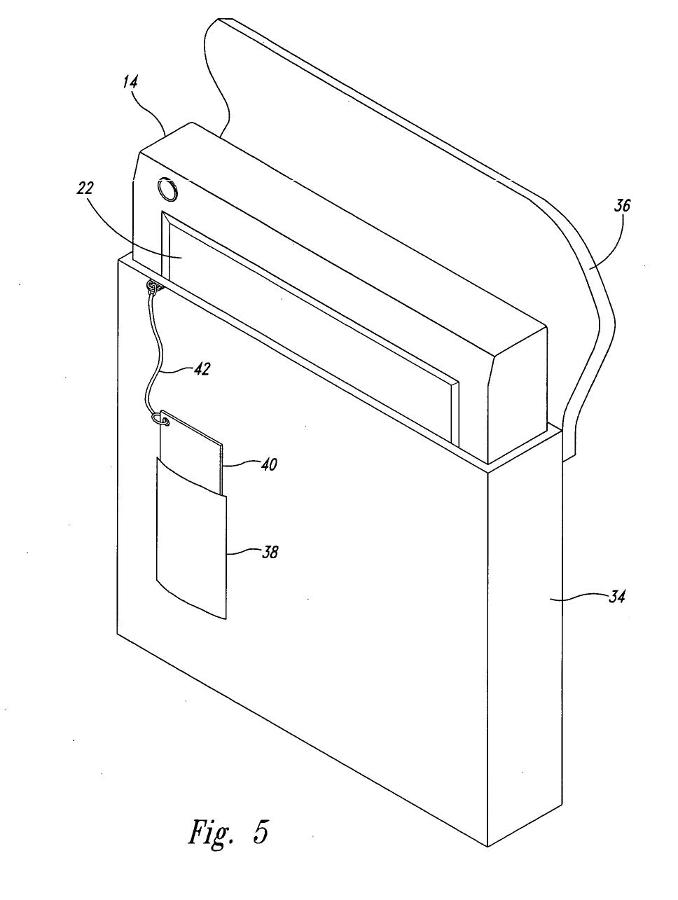

A protective pouch 34 with a closure flap 36 is sized to snugly contain one of the self-contained IFEDs 14 as shown in FIG. 5. The protective pouch 34 includes a pocket 38 for carrying an IFED identification card 40. A cord 42 is attached both to the IFED identification card 40 and the protective pouch 34 to separation of the IFED identification card from the protective pouch and its possible loss. In some implementations, the IFED identification card 40 contains magnetically coded information, including the self-contained IFED 14 present in the protective pouch.

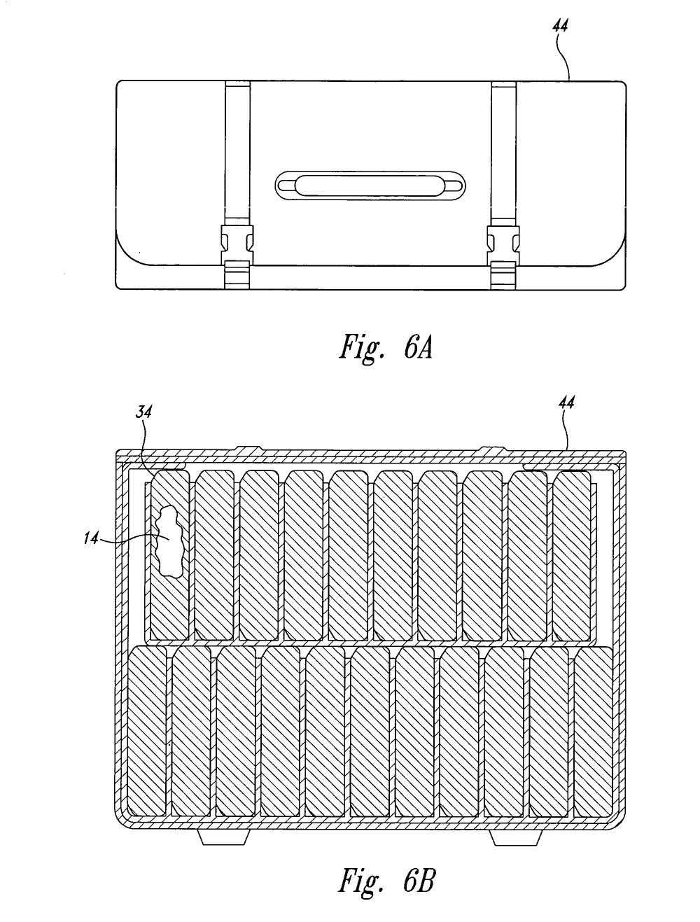

An IFED carrying case 44, shown in FIGS. 6A and 6B, is constructed for hand carry transport of a large number of the self-contained IFEDs 14 to the in-flight storage 30 on the aircraft 26. Each of the self-contained IFEDs 14 is first placed in one of the protective pouches 34 before being placed in respective slots of the IFED carrying case 44. This occurs prior to delivery of the IFED carrying case 44 to the in-flight storage 30.

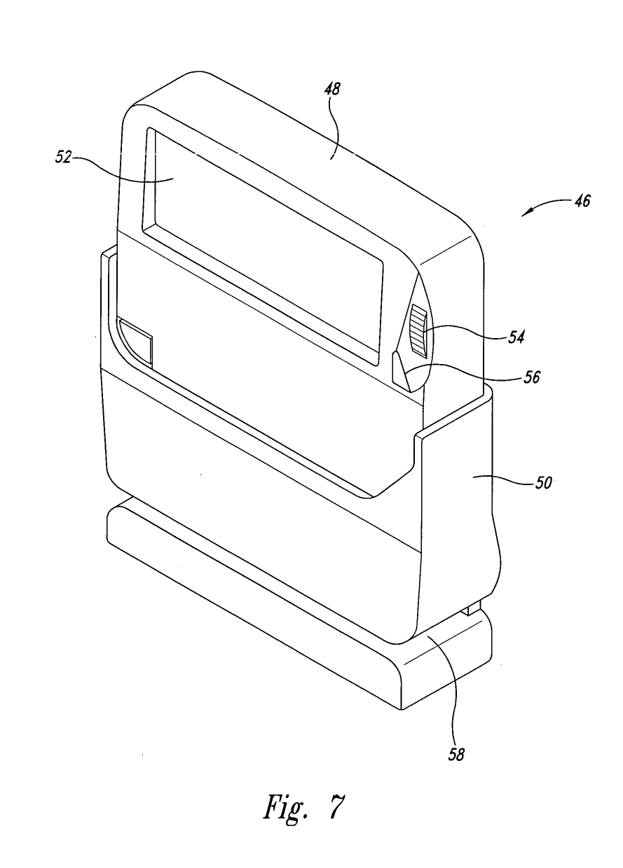

A wireless card swipe unit 46 has a control section 48 and a swipe input section 50 as shown in FIG. 7. The control section 48 includes a display 52 for viewing one or more lists of selections and a roller-knob 54 for scrolling through the selection lists by rotating the roller-knob and subsequently selecting an item on one of the selection lists by depressing the roller-knob. A contrast adjust button 56 allows for adjustment of the display 52. The swipe input section 50 includes a swipe slot 58 for swiping electronic cards having magnetically coded information such as credit cards, debit cards, and those of the IFED identification card 40 that also contain magnetically coded information.

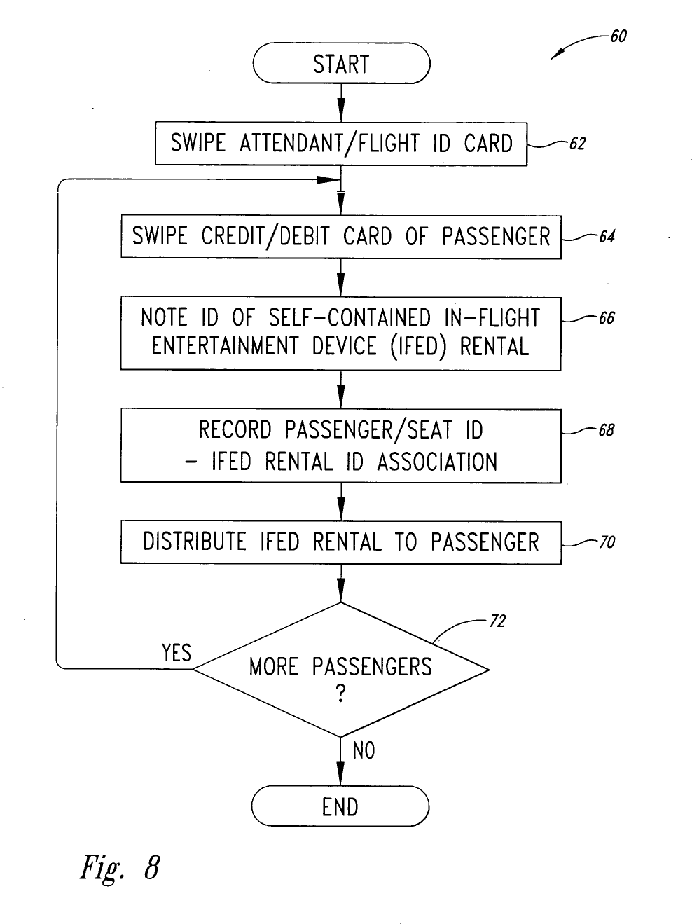

A method 60 of payment during distribution for rental of the self-contained IFEDs 14 to the passengers 10 on the aircraft 26 is shown in FIG. 8 as the method 60 begins with the flight attendant swiping an attendant identification card with the card swipe unit 46 (step 62) prior to distributing the self-contained IFEDs 14 to the passengers 10. The attendant identification card typically contains the attendant's name and the identification number of the flight, which is read and stored in the card swipe unit 46. To distribute one of the self-contained IFEDs 14 to one of the passengers 10 requesting use of the self-contained IFED, the flight attendant swipes a financial card, such as a credit or debit card, of the passenger with the card swipe unit 46 (step 64) to collect passenger identification and payment information, which is read and stored in the card swipe unit.

Identification of the particular one of the self-contained IFEDs 14 being distributed (rented) to the passenger 10 is noted (step 66) through several possible means. Selection of a menu item through use of the roller-knob 54 can generally note that one of the self-contained IFEDs 14 is being rented. In some implementations, the flight attendant swipes the IFED identification card 40 attached to the protective pouch 34 containing the self-contained IFED 14 being distributed to the passenger 10 and the card swipe unit 46 reads and stores the identification of the particular self-contained IFED being rented and associates it with the passenger identification and payment information.

Another way of noting which of the self-contained IFEDs 14 was rented to a particular passenger 10 is for the flight attendant to mark an identification number of the self-contained IFED appearing on the self-contained IFED or its protective pouch 34 on a clear plastic sheet (typically, affixed to the carrying case 44) having a map of the seating arrangement of the plane. Also, the flight attendant can put a paper copy of a financial card transaction receipt into the slot of the carrying case 44 previously occupied by the particular self-contained IFED 14 being distributed (rented). This creates a record of the passenger renting the self-contained IFED using the passenger-seat identification correlated with the identification of particular self-contained IFED rented. Making an association of which self-contained I FED 14 was rented by a particular one of the passengers 10 is helpful in case a rented self-contained IFED is not returned and later determined to be missing. This association is accomplished and recorded (step 68), either electronically through the card swipe unit 46 or manually such as through the plastic seating map/transaction receipt methods discussed above.

The self-contained IFED 14 is then given to the passenger 10 to use on the flight (step 70). If more passengers are requesting self-contained IFEDs 14 (“YES” branch of decision step 72), then the method 60 returns to step 64, otherwise (“NO” branch of decision step 72), the method ends.

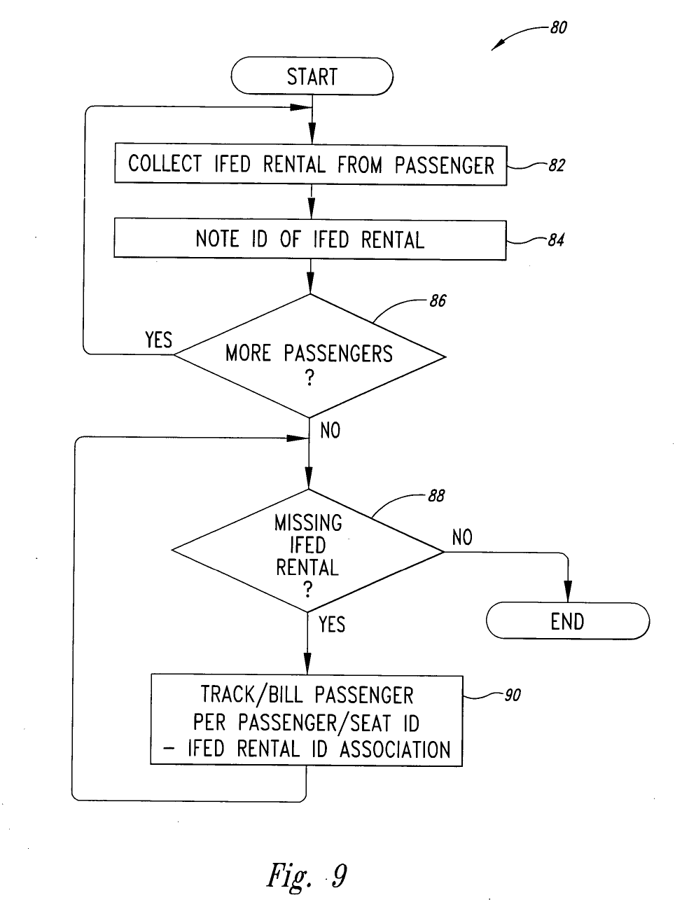

A method 80 of collection of the rented self-contained IFEDs 14, typically near the end of the flight is shown in FIG. 9 as beginning with a flight attendant receiving one of the rented self-contained IFEDs from one of the passengers 10 (step 82). The identification of the received self-contained IFED 14 is then recorded (step 84), either electronically such as through use of the IFED identification card 40 for the returned self-contained IFED attached to its protective pouch 34 being swiped with the card swipe unit 46 or manually such as with the plastic seating map or with the paper financial transaction receipt previously placed in the slot of the carrying case 44 associated with the returned self-contained IFED. If more of the self-contained IFEDs 14 need to be collected from the passengers 10 (“YES” condition of decision step 86), the method 80 returns to step 82, otherwise (“NO” condition of decision step 86), the method goes to decision step 88.

After attempting to collect all the self-contained IFEDs 14 from the passengers 10 of the aircrafts 26, or at least those for whom the flight attendant is responsible, if the electronic or manual records previously made in steps 66 and 68 indicate that one or more of the self-contained IFEDs are missing (“YES” condition of decision step 88), the missing one or more self-contained IFEDs are identified and associated passengers are billed for the missing self-contained IFEDs. This is done using the association of the passenger name or the passenger-seat identification correlated with the identification of the particular missing self-contained IFED using the rental records created in step 68. When all such billing for missing self-contained IFEDs 14 is done (“NO” condition of decision step 88), the method 80 ends.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A method to be performed on-board a commercial aircraft, the method comprising:
electronically swiping an identification card indicating attendant and commercial airline flight;
electronically swiping a financial card to collection identification information for payment of rental of a self-contained in-flight entertainment device;
distributing the self-contained in-flight entertainment device to a passenger;
noting an identification of the self-contained in-flight entertainment device; and
recording an association between the identification of the self-contained in-flight entertainment device and information associated with the passenger.

2. The method of claim 1 wherein the recording is done by writing an identification number of the self-contained in-flight entertainment device on a clear plastic map of seating of the aircraft.

3. The method of claim 1 wherein the recording is done by placing a paper copy of a finance transaction related to the swiping of the financial card into a slot of a carrying case previously holding the self-contained in-flight entertainment device.

4. The method of claim 1 wherein the recording of the association has information associated with the passenger consisting of at least one of the following: the identification information from the financial card, identification of seating for the passenger, and identification information of the passenger.

5. The method of claim 1 wherein the financial card being electronically swiped is a credit card of the passenger.

6. A method to be performed on-board a commercial aircraft comprising:
distributing self-contained in-flight entertainment devices to passengers for their use on-board the commercial aircraft in exchange for payment with a financial card;
recording an association between the self-contained in-flight entertainment devices and the passengers using them;
collecting the self-contained in-flight entertainment devices from passengers;
determining if any one of the self-contained in-flight entertainment devices was not collected and if so, determining from the association, which one of the passengers was non-compliant for such non-collection; and
charging the financial card for the uncollected self-contained in-flight entertainment device.
